(19) United States
(12) Patent Application Publication
(10) Pub. No.: US 2003/0175459 A1
(43) Pub. Date: Sep. 18, 2003

(54) Flame retardant shaped articles

(76) Inventors: Raman Patel, Cumberland, RI (US); Robert Washburn, Amherst, OH (US); John C. Andries, East Greenwich, RI (US)

Correspondence Address: FISH & RICHARDSON PC, 225 FRANKLIN ST, BOSTON, MA, 02110, US

(21) Appl. No.: 10/215,617

(22) Filed: Aug. 9, 2002

Related U.S. Application Data
(63) Continuation of application No. 10/052,818, filed on Jan. 16, 2002.
(60) Provisional application No. 60/261,998, filed on Jan. 16, 2001.

(51) Int. Cl. B32B 1/08

(52) U.S. Cl. 428/36.9

(57) ABSTRACT

A shaped article is disclosed. The article includes a polymer composition that includes an olefinic polymer; a polar polymer; and a third polymer. The third polymer is a graft or block copolymer having first and second polymer portions. The first polymer portion is compatible with the olefinic polymer and the second polymer portion is compatible with the polar polymer. The polymer composition has a limiting oxygen index of at least about 25.

### CROSS-REFERENCE TO RELATED APPLICATIONS

This application claims priority from provisional application No. 60/261,998, filed Jan. 16, 2001.

### BACKGROUND

This invention relates to articles made from polymer compositions, and more particularly to articles made from flame-retardant polymer compositions.

Polymer compositions can include polar polymers and olefinic polymers. These polymer compositions often include one or more additional compounds that act as compatibilizers for the polar and olefinic polymers. In addition, they can include additives that render the compositions flame retardant.

### SUMMARY

The invention relates to polymer compositions. These compositions can exhibit good flame retardancy and/or low smoke generation. The polymer compositions can provide good mechanical properties, such as tensile strength. The compositions can have a combination of desirable properties, such as high tensile strength, high flex modulus, and a high limiting oxygen index.

The compositions can be suitable for use in shaped articles such as pipes, conduits, tube beams, and ducts, particularly for wire and cable applications. For example, the compositions can be used to make optical fiber conduits and extruded cable jackets. Thus, flame retardant conduits and pipes can be prepared using the compositions described herein. The polymer compositions can be substantially halogen-free. The compositions can be in the form of a blend.

In one aspect, the invention features a shaped article including a polymer composition. The polymer composition includes: an olefinic polymer; a polar polymer; and a third polymer. The third polymer is a graft or block copolymer with first and second polymer portions, the first polymer portion being compatible with the olefinic polymer and the second polymer portion being compatible with the polar polymer. The polymer composition has a limiting oxygen index (LOI) of at least about 25.

The article may be, e.g., a pipe, a tube, a conduit (e.g., an optical fiber conduit), or a duct. Preferably, the weight ratio of the polar polymer to the olefinic polymer is 1:1 or greater. For example, the weight ratio of the polar polymer to the olefinic polymer can be between 1:1 and 10:1 or between 1:1 and 5:1.

Preferably, the polymer composition contains a sufficient amount of the third polymer such that the tensile strength of the composition is improved by at least about 20%, relative to a composition without the third polymer. For example, the tensile strength can be improved by at least about 30%, 40%, 50%, 60%, or 70%. In preferred embodiments, both the olefinic polymer and the polar polymer are substantially free of halogens. The entire composition can be essentially free of halogens.

The article can consist essentially of the polymer composition. Preferably, the polymer composition has a limiting oxygen index of at least about 30, 35, or 40. In addition, the composition preferably has a tensile strength of at least 1500 psi or 1800 psi and/or a flex modulus of at least 80 Kpsi or 85 Kpsi.

A “shaped article” is an article that is rigid enough to maintain its shape. A shaped article can be made with a material having a flex modulus of about 80 to about 200 Kpsi and a tensile strength of about 1500 psi or greater.

The details of one or more embodiments of the invention are set forth in the detailed description below. Other features, objects, and advantages of the invention will be apparent from the description, and from the claims.

### DETAILED DESCRIPTION

The preferred compositions include an olefinic polymer, a polar polymer and a compatibilizer. The compatibilizer can be a block or graft copolymer. The compatibilizer includes at least one olefinic polymer portion that is compatible with the olefinic polymer, and at least one polar polymer portion that is compatible with the polar polymer. The polymer portions can be in the form of blocks.

Typically, the compositions are in the form of a blend in which the components of the composition are intermixed. The blend can be a homogeneous blend.

Olefinic polymers are formed primarily of olefin monomers which are hydrocarbon monomers having at least one carbon-carbon double bond. Olefin monomers can be straight chained, branched or cyclic hydrocarbons. Examples of olefin monomers include ethylene, propylene, butylene and pentene. Examples of olefinic polymers include polyethylene, ethylene copolymers, polypropylene, propylene copolymers, ethylene propylene copolymers and polymethylpentene polymers.

In addition to olefin monomers, an olefinic polymer can include a minor amount of non-olefinic monomers, such as ethylene acrylic monomers. Preferably, an olefinic polymer includes less than about 20 weight percent non-olefinic monomers, more preferably less than about 10 weight percent non-olefinic monomers and most preferably less than about 5 weight percent non-olefinic monomers.

Preferably, an olefinic polymer includes at least about 80 weight percent olefin monomers, more preferably at least about 90 weight percent olefin monomers, and most preferably at least about 95 weight percent olefin monomers.

Olefinic polymers preferably include less than about 2 weight percent halogen, more preferably less than about 1 weight percent halogen and most preferably less than about 0.5 weight percent halogen.

Olefinic polymers are available from, for example, Exxon, Mobil, Chevron, Amoco, Dow, Quantum, Solvay, Novacor, Rexene, Aristech, Hoechst Celanese, Fina, Montall and Shell.

A polar polymer includes olefin monomers and polar monomers having the formula CH₂═CHOCOR, where R is a hydrocarbon group that can be straight chained or branched, saturated or unsaturated, and substituted or unsubstituted. Typically, R is a straight chained, saturated and unsubstituted alkyl group having from one to five carbon atoms, such as a methyl group, an ethyl group or a butyl group. In a polar polymer, a portion of the polar monomers can be hydrolyzed.

A polar polymer can include additional functional monomers such as carbon monoxide, acrylic monomers, glycidyl acrylic monomers, acid monomers, anhydride monomers and/or nitrile monomers.

Preferably, a polar polymer includes from about 20 weight percent to about 90 weight percent olefinic monomers, more preferably from about 35 weight percent to about 85 weight percent olefinic monomers, and most preferably from about 50 weight percent to about 80 weight percent olefinic monomers.

Preferably, a polar polymer includes from about 10 weight percent to about 80 weight percent polar monomers, more preferably from about 15 weight percent to about 65 weight percent polar monomers, and most preferably from about 20 weight percent to about 50 weight percent polar monomers.

Preferably, a polar polymer includes at most about 15 weight percent additional functional monomers, more preferably from about 2.5 weight percent to about 10 weight percent additional functional monomers.

Polar polymers preferably include less than about 2 weight percent halogen, more preferably less than about 1 weight percent halogen, and most preferably less than about 0.5 weight percent halogen.

In a preferred embodiment, the polar polymer is a terpolymer of ethylene monomers, vinyl acetate monomers and carbon monoxide.

Polar polymers are available from, for example, Exxon, Quantum, DuPont, Union Carbide, AT Plastics, Chevron, Bayer, Mitsubishi Petrochemicals and Sumitomo.

The compatibilizer is typically a graft or block copolymer that includes at least one olefinic polymer portion and at least one polar polymer portion. The polymer portions can be in the form of blocks.

The olefinic polymer portion is formed of an olefinic polymer, and the polar polymer portion is formed of a polar polymer. The olefinic polymer portion should be selected to be compatible with the olefinic polymer, and the polar polymer portion should be selected to be compatible with the polar polymer. Generally, the olefinic polymer portion of the compatibilizer and the olefinic polymer have substantially the same polarity, and the polar polymer portion of the compatibilizer and the polar polymer have substantially the same polarity.

Preferably, the olefinic polymer portion of the compatibilizer is the same polymer as the olefinic polymer. For example, if the olefinic polymer is polyethylene, the olefinic polymer portion of the compatibilizer is also polyethylene.

Preferably, the polar polymer portion of the compatibilizer includes functional groups that are the same as the functional groups in the polar polymer. For example, if the polar polymer is ethylene vinyl acetate, the polar polymer portion of the compatibilizer includes vinyl acetate monomers.

The polymer compositions can include from about 15 weight percent to about 65 weight percent ethylenic polymer, from about 20 weight percent to about 80 weight percent polar polymer, and from about 1 weight percent to about 40 weight percent compatibilizer.

The olefinic polymer portions and polar polymer portions of the compatibilizer can be directly chemically bonded or they can be connected by a linking agent that is chemically bonded to an olefinic polymer portion and an adjacent polar polymer portion.

When a linking agent is not used, the compatibilizer can be formed by reacting two polymers that contain functional groups that react to provide the compatibilizer. This reaction can occur in a mixture that contains the olefinic polymer and the polar polymer. Alternatively, the compatibilizer can first be formed then added to a mixture that contains the olefinic polymer and the polar polymer.

An amine and/or epoxy containing polymer, such as a nitrile rubber, can be reacted with an acid or anhydride containing polyolefin. An acid or anhydride containing polymer, such as a nitrile rubber, can be reacted with an amine and/or epoxy containing polyolefin. An isocyanate containing polyester (typically having a low molecular weight) can be reacted with an acid, anhydride or epoxy containing polyolefin. A compatibilizer can be formed by reacting an epoxy containing terpolymer of ethylene, vinyl acetate and carbon monoxide with a maleic acid modified polypropylene. A compatibilizer can be formed by reacting an ethylene methyl acrylate acid containing polar polymer with an epoxy containing styrene ethylene butylene styrene block copolymer.

Preferably, the functional groups that react to form the compatibilizer are at the terminus of the polymers.

Examples of linking agents include diepoxides, diamines and diisocyanates which can be reacted with an acid modified polar polymer and an acid modified olefinic polymer to provide a compatibilizer.

The polymer compositions can be prepared using standard mixing methods. For example, the polymer compositions can be formed using a Banbury mixer, a Brabender mixer and/or a twin screw mixer. Generally, twin screw mixers provide a higher shear during mixing, so polymer compositions formed using a twin screw extruder can exhibit better elongation and tensile properties. The polymer compositions can also include silicones, stabilizers, flame retardants, plasticizers, colorants, reinforcing fillers, lubricants, and/or compounds that improve the hydrolytic stability of esters. Preferably, the total amount of these compounds in the polymer compositions is from about 50 to about 200 parts per 100 parts of total amount of polymer (ethylenic polymer, polar polymer and compatibilizer). When the composition includes anti-oxidants or lubricants, these compounds make up from about 100 parts per million to about 10 weight percent of the composition relative to the total amount of polymer (ethylenic polymer, polar polymer and compatibilizer).

Examples of compounds that improve the stability of esters include polycarbodiimides, such as aromatic polycarbodiumides. These compounds are available from, for example, Bayer.

Examples of colorants include organic and inorganic colorants. Colorants are available from, for example, Ciba Geigy, BASF, Ferro, ICI, Harwick and Teknor Apex.

Examples of flame retardants include aluminum trihydrate, magnesium hydroxide, phosphorus compounds, nitrogen compounds, zinc borates, halogenated compounds, and Ultracarb (Microfine Minerals). Flame retardants are available from, for example, Lonza, Alcoa, Alcan, Huber, Martin Marietta, Hoechst Celanese, U.S. Borax, Melamine Chemicals, Microfine Minerals and Anzon. The compositions preferably include enough flame retardant such that the compositions have a limiting oxygen index of at least about 25.

Examples of stabilizers include heat stabilizers, metal deactivators and ultraviolet stabilizers. Stabilizers are available from, for example, Ciba Geigy, Sandoz, Cytec, Eastman Chemicals, Fairmount Chemicals, Hoechst Celanese and General Electric.

Examples of plasticizers include phosphate ester plasticizers, phosphoric esters, fatty acid esters, esters of azelaic acid, esters of sebacic acid, trimellitic esters and polymeric plasticizers. When the polymer compositions are used in flame retardant applications, phosphate ester plasticizers are preferably used. Plasticizers are available from, for example, Solutia, Teknor Apex, Ferro, Exxon, Eastman Chemical and Uniflex Chemical.

Lubricants are available from, for example, Akzo, Dow Corning, DuPont, Astor Wax, Henkel, Witco and Struktol.

Silicones are available from, for example, General Electric, Wacker silicones and Dow Corning.

Examples of reinforcing fillers include clay, silica and calcium carbonate. Reinforcing fillers are available from, for example, Huber, Engelhard and PPG.

The polymer compositions preferably have an elongation of at least about 50% as measured according to ASTM D-638.

The polymer compositions preferably have a tensile strength of at least about 1800 as measured according to ASTM D-638.

The polymer compositions preferably have a flex modulus of at least about 80 Kpsi as measured according to ASTM D-790.

The polymer compositions preferably have a peak smoke rating of less than 2/meter as measured using cone calorimetry according to ASTM E-1354.

When prepared for use as a flame retardant material, the polymer compositions preferably have a limiting oxygen index of at least about 25 as measured by ASTM D-2863. More preferably, the compositions have a limiting oxygen index of at least about 30, 35, or 40.

Tables I-V list polymer compositions and their properties. Compositions 1-9 and 11-25 were prepared using a Brabender mixer (PL 2000 equipped with roller type blades). Composition 10 was prepared using a Banbury mixer, as described below. For compositions 1-9 and 11-25, the speed was adjusted to keep the mixture at about 180° C. The polymers were first mixed, and the filler was slowly added. This mixture was mixed for about five minutes, and the stabilizer was added. This mixture was re-mixed for about one minute, removed from the Brabender mixer and pressed to a thin sheet in a cool press. The resulting material was compression molded at 220° C. This material was then cooled and the properties of the material were evaluated.

Alternatively, the compositions can be prepared using a twin screw extruder (Berstoff Model 40). All ingredients are metered and added at the feed throat. The temperature is controlled such that the temperatures in the mixing zones is at most about 420° F. The mixing speed is about 120-200 rpm.

Alternatively, the compositions can be prepared by mixing the olefinic polymers and polar polymers in a Banbury mixer (Farrel Midget Banbury mixer) using a medium rotor speed. When the temperature reaches about 10° C. above the melting point of the polyethylene, the mixing speed is reduced to low for about 5 minutes. About one half of the filler (magnesium hydroxide) is added, and then the remaining half of the filler is added. The mixing speed is reduced, and the stabilizers are added while maintaining a low rotor speed. The resulting mixture is molded as described above. Procedures for preparing polymer compositions are described in more detail in Patel et al., U.S. Pat. No. 6,034,176, which is incorporated by reference in its entirety. The polymer compositions can be formed into shaped articles, such as pipes, using techniques known in the art.

A number of compositions and their properties are set forth in Tables I-V below.

TABLE 1

| | 1 | 2 | 3 | 4 | 5 |
|---|---|---|---|---|---|
| Raw Material | | | | | |
| Ethylene Vinyl Acetate | 60 | 30 | | 30 | 40 |
| copolymer¹ | | | | | |
| Ethylene Vinyl Acetate | | 30 | 60 | 30 | 30 |
| copolymer² | | | | | |
| HDPE³ | 15 | 15 | 15 | 15 | 15 |
| Ethylene butyl acrylate | 5 | 5 | 5 | 5 | 3 |
| epoxide⁴ | | | | | |
| Maleic Acid Modified | 5 | 5 | 5 | 5 | 2 |
| Ethylene Vinyl Acetate | | | | | |
| terpolymer⁵ | | | | | |
| Maleic Acid Modified | 15 | 15 | 15 | 15 | 10 |
| Polyethylene⁶ | | | | | |
| Magnesium hydroxide⁷ | 180 | 180 | 180 | 180 | 180 |
| Silane coupling agent⁸ | 2 | 2 | 2 | 2 | 2 |
| Magnesium hydroxide⁹ | | | | | |
| Magnesium hydroxide¹⁰ | | | | | |
| Magnesium hydroxide¹¹ | | | | | |
| Stearic acid | 0.50 | 0.50 | 0.50 | 0.50 | 0.50 |
| Zinc stearate¹² | 0.40 | 0.40 | 0.40 | 0.40 | 0.40 |
| Calcium stearate | 0.20 | 0.20 | 0.20 | 0.20 | 0.20 |
| Anti-oxidant¹³ | 1.00 | 1.00 | 1.00 | 1.00 | 1.00 |
| Anti-oxidant¹⁴ | 0.40 | 0.40 | 0.40 | 0.40 | 0.40 |
| Hindered amine light | 0.20 | 0.20 | 0.20 | 0.20 | 0.20 |
| stabilizer¹⁵ | | | | | |
| Resin modifier¹⁶ | 5.00 | 5.00 | 5.00 | 5.00 | 5.00 |
| Silicone lubricant¹⁷ | | | | 3.00 | |
| Total | 289.70 | 289.70 | 289.70 | 292.70 | 289.70 |
| Properties | | | | | |
| Specific Gravity | 1.48 | 1.50 | 1.49 | 1.49 | 1.49 |
| Hardness, Shore D | 67/62 | 67/62 | 65/60 | 66/61 | 65/60 |
| (Inst/10 sec) | | | | | |
| Tensile Strength (TAPEs), | 2090 | 2260 | 2310 | 2360 | 2170 |
| psi | | | | | |
| Elongation @ Break | 75 | 66 | 75 | 85 | 69 |
| (TAPEs), % | | | | | |
| Flex Modulus, Kpsi | 100.0 | 92.2 | 99.2 | 99.5 | 98.6 |
| LTB, ° C. | −21 | −11 | −13 | −12 | −11 |
| Melt Index, g/10 min | 0/0.21 | 0/0.25 | 0/0.20 | 0/0.35 | 0.26/1.29 |
| (190° C./10, 20 kg) | | | | | |
| Dielectric constant @ | 3.49 | 3.40 | 3.48 | 3.50 | 3.55 |
| 1 KHz | | | | | |
| Dissipation factor @ | 0.0090 | 0.0078 | 0.0027 | 0.0027 | 0.0028 |
| 1 KHz | | | | | |
| Volume resistivity, | 2.125 | 2.271 | 2.406 | 1.461 | 0.874 |
| X10\hat{ }14 | | | | | |
| LOI, % | 40 | 41 | 41 | 41 | 41 |
| Peak Heat Release | 148 | 174 | 154 | 148 | 145 |
| Rate @ 50 Kw/sqm, | | | | | |
| Kw/sqm | | | | | |
| Average Heat Release | 84 | 97 | 91 | 87 | 88 |
| Rate @ 50 Kw/sqm, | | | | | |
| Kw/sqm | | | | | |
| Average Heat Release | 115 | 124 | 112 | 124 | 114 |
| Rate @ 50 Kw/sqm @ | | | | | |
| 3 min, Kw/sqm | | | | | |
| Total heat release @ | 172 | 170 | 163 | 165 | 165 |
| 50 Kw/sqm, MJ/sqm | | | | | |
| Peak smoke @ | 0.5 | 1.5 | 1.0 | 0.6 | 1.0 |
| 50 Kw/sqm, 1/m | | | | | |
| Time to sustained | 170 | 175 | 155 | 163 | 154 |
| ignition, sec | | | | | |
| Viscosity @ 230° C., L/D | | | | | |
| 16/1, 1126N PF | | | | | |
| Calc. Visc. Pas⁻¹ | | | | | |
| @ Shear rate 100 s⁻¹ | 4593 | 3844 | 3295 | 3228 | 2960 |
| @ Shear rate 200 s⁻¹ | 2753 | 2384 | 1982 | 2019 | 1870 |
| @ Shear rate 500 s⁻¹ | 1470 | 1307 | 1057 | 1072 | 1030 |
| @ Shear rate 1000 s⁻¹ | 949 | 849 | 680 | 678 | 661 |

¹Elvax 470, commercially available from DuPont
²Elvax 460, commercially available from DuPont
³HDPE HMAO34B, commerically available from Exxon Chemicals
⁴Elvaloy AS, commercially available from DuPont
⁵Fusabond C MC 250D, commercially available from DuPont
⁶Fusabond EMB 100D, commercially available from DuPont
⁷Magnifin H-10
⁸commercially available from Dow Corning or OSI
⁹Magshield, commerically available from Martin Marietta
¹⁰Kisuma 5A, commercially available from Kisuma Chemicals BV, the Netherlands
¹¹Kisuma 5B, commercially available from Kisuma Chemicals BV, the Netherlands
¹²Coad 21
¹³Irganox 1010, commercially available from Ciba-Geigy
¹⁴Irganox 1024 MD, commercially available from Ciba-Geigy
¹⁵Chimassorb 944FD, commerically available from Ciba-Geigy
¹⁶4-7051, commercially available from Dow Corning
¹⁷MB 50-314, commercially available from Dow Corning

TABLE II

| | 6 | 7 | 8 | 9 | 10 |
|---|---|---|---|---|---|
| Raw Material | | | | | |
| Ethylene Vinyl Acetate copolymer¹ | 40 | 30 | 30 | 30 | 30 |
| Ethylene Vinyl Acetate copolymer² | 30 | 30 | 30 | 30 | 30 |
| HDPE³ | 15 | 15 | 15 | 15 | 15 |
| Ethylene butyl acrylate epoxide⁴ | 3 | 5 | 5 | 5 | 5 |
| Maleic Acid Modified Ethylene | 2 | 5 | 5 | 5 | 5 |
| Vinyl Acetate terpolymer⁵ | | | | | |
| Maleic Acid Modified Polyethylene⁶ | 10 | 15 | 15 | 15 | 15 |
| Magnesium hydroxide⁷ | | | | | |
| Silane coupling agent⁸ | 2 | 2 | 2 | 2 | 2 |
| Magnesium hydroxide⁹ | 180 | 180 | | | |
| Magnesium hydroxide¹⁰ | | | 180 | | 180 |
| Magnesium hydroxide¹¹ | | | | 180 | |
| Stearic acid | 0.50 | 0.50 | 0.50 | 0.50 | 0.50 |
| Zinc stearate¹² | 0.40 | 0.40 | 0.40 | 0.40 | 0.40 |
| Calcium stearate | 0.20 | 0.20 | 0.20 | 0.20 | 0.20 |
| Anti-oxidant¹³ | 1.00 | 1.00 | 1.00 | 1.00 | 1.00 |
| Anti-oxidant¹⁴ | 0.40 | 0.40 | 0.40 | 0.40 | 0.40 |
| Hindered amine light stabilizer¹⁵ | 0.20 | 0.20 | 0.20 | 0.20 | 0.20 |
| Resin modifier¹⁶ | 5.00 | 5.00 | 5.00 | 5.00 | 5.00 |
| Silicone lubricant¹⁷ | | 3.00 | | | 3.00 |
| Total | 289.70 | 292.70 | 289.70 | 289.70 | 292.70 |
| Properties | | | | | |
| Specific Gravity | 1.45 | 1.50 | 1.49 | 1.49 | 1.49 |
| Hardness, Shore D (Inst/10 sec) | 66/61 | 65/60 | 63/58 | 65/59 | 64/58 |
| Tensile Strength (TAPEs), psi | 1770 | 1820 | 1870 | 1920 | 1880 |
| Elongation @ Break (TAPEs), % | 62 | 79 | 25 | 25 | 26 |
| Flex Modulus, Kpsi | 83.6 | 81.3 | 93.3 | 77.3 | 85.5 |
| LTB, ° C. | >0 | >0 | >0 | >0 | >0 |
| Melt Index, g/10 min (190° C./10, | 0.23/1.35 | 0.11/0.68 | 0.26/1.72 | 0.15/1.09 | 0.38/3.17 |
| 20 kg) | | | | | |
| Dielectric constant @ 1 KHz | 3.96 | 3.81 | 3.41 | 3.27 | 3.32 |
| Dissipation factor @ 1 KHz | 0.0108 | 0.0080 | 0.0056 | 0.0050 | 0.0241 |
| Volume resistivity, X10\hat{ }14 | 1.915 | 1.962 | 0.453 | 0.327 | 4.33 |
| LOI, % | 40 | 38 | 41 | 39 | 41 |
| Peak Heat Release Rate @ 50 | 156 | 155 | 140 | 136 | |
| Kw/sqm, Kw/sqm | | | | | |
| Average Heat Release Rate @ 50 | 80 | 79 | 77 | 80 | |
| Kw/sqm, Kw/sqm | | | | | |
| Average Heat Release Rate @ 50 | 126 | 129 | 111 | 102 | |
| Kw/sqm @ 3 min, Kw/sqm | | | | | |
| Total heat release @ 50 Kw/sqm, | 171 | 160 | 170 | 163 | |
| MJ/sqm | | | | | |
| Peak Smoke @ 50 Kw/sqm, 1/m | 0.5 | 0.8 | 0.7 | 0.7 | |
| Time to sustained ignition, sec | 177 | 170 | 165 | 126 | |
| Viscosity @ 230° C., L/D 16/1, | | | | | |
| 1126N PF | | | | | |
| Calc. Visc. Pas⁻¹ | | | | | |
| @ Shear rate 100 s⁻¹ | 3500 | 2912 | 2603 | 2499 | 2128 |
| @ Shear rate 200 s⁻¹ | 2241 | 1881 | 1665 | 1595 | 1334 |
| @ Shear rate 500 s⁻¹ | 1217 | 1009 | 930 | 896 | 740 |
| @ Shear rate 1000 s⁻¹ | 755 | 609 | 601 | 586 | 484 |

¹⁻¹⁷The raw materials in Table II are the same as those listed in Table I

TABLE III

| | 11 | 12 | 13 | 14 | 15 |
|---|---|---|---|---|---|
| Raw Material | | | | | |
| Ethylene Vinyl Acetate copolymer¹ | 40 | 40 | 30 | 40 | 60 |
| Ethylene Vinyl Acetate copolymer² | 30 | 30 | 30 | 30 | |
| HDPE³ | 15 | 20 | 15 | 20 | 15 |
| Epoxidized polyethylene⁴ | | | | | |
| Ethylene butyl acrylate epoxide⁵ | 3 | 3 | 5 | 3 | 5 |
| Maleic Acid Modified Ethylene | 2 | 2 | 5 | 2 | 5 |
| Vinyl Acetate terpolymer⁶ | | | | | |
| Maleic Acid Modified Polyethylene⁷ | 10 | 5 | 15 | 5 | 15 |
| Magnesium hydroxide⁸ | 160 | 160 | 160 | | 180 |
| Silane treated magnesium hydroxide⁹ | 20 | 20 | 20 | 20 | |
| Magnesium hydroxide¹⁰ | | | | 160 | |
| Silane treated magnesium | | | | | |
| hydroxide¹¹ | | | | | |
| Phosphate plasticizer¹² | | | | | |
| Stearic acid | 0.50 | 0.50 | 0.50 | 0.50 | 0.50 |
| Zinc stearate¹³ | 0.40 | 0.40 | 0.40 | 0.40 | 0.40 |
| Calcium stearate | 0.20 | 0.20 | 0.20 | 0.20 | 0.20 |
| Anti-oxidant¹⁴ | 1.00 | 1.00 | 1.00 | 1.00 | 1.00 |
| Anti-oxidant¹⁵ | 0.40 | 0.40 | 0.40 | 0.40 | 0.40 |
| Hindered amine light stabilizer¹⁶ | 0.20 | 0.20 | 0.20 | 0.20 | 0.20 |
| Resin modifier¹⁷ | 5.00 | 5.00 | 5.00 | 5.00 | 5.00 |
| Silicone lubricant¹⁸ | | | | | |
| Silane coupling agent 19 | | | | | 2 |
| Total | 287.70 | 287.70 | 287.70 | 287.70 | 287.70 |
| Properties | | | | | |
| Specific Gravity | 1.49 | 1.49 | 1.49 | 1.51 | 1.51 |
| Hardness, Shore D (Inst/10 sec) | 65/60 | 58/51 | 59/52 | 64/58 | 68/63 |
| Tensile Strength (TAPEs), psi | 2170 | 1890 | 1900 | 1770 | 2110 |
| Elongation @ Break (TAPEs), % | 69 | 52 | 28 | 19 | 58 |
| Flex Modulus, Kpsi | 98.6 | | | | |
| LTB, ° C. | −11 | −23 | −22 | −6 | −21 |
| Melt Index, g/10 min (190° C./10, | 0.26/1.29 | 0.22/4.46 | 0.22/2.44 | 1.55/11.86 | 0.10/1.10 |
| 20 kg) | | | | | |
| Dielectric constant @ 1 KHz | 3.55 | 3.42 | 3.46 | 3.38 | 3.54 |
| Dissipation factor @ 1 KHz | 0.0028 | 0.0032 | 0.0032 | 0.0031 | 0.0036 |
| Volume resistivity, X10\hat{ }14 | 0.874 | | | 1.880 | 11.3330 |
| LOI, % | 41 | | | | 41 |
| Peak Heat Release Rate @ 50 | 145 | 151 | 128 | 127 | 147 |
| Kw/sqm, Kw/sqm | | | | | |
| Average Heat Release Rate @ 50 | 88 | 92 | 79 | 75 | 95 |
| Kw/sqm, Kw/sqm | | | | | |
| Average Heat Release Rate @ 50 | 114 | 116 | 100 | 103 | 131 |
| Kw/sqm @ 3 min, Kw/sqm | | | | | |
| Total heat release @ 50 Kw/sqm, | 165 | 150 | 146 | 138 | 157 |
| MJ/sqm | | | | | |
| Effective HOC, MJ/kg | | | | | |
| Peak Smoke @ 50 Kw/sqm, 1/m | 1.0 | 0.9 | 0.9 | 0.6 | 1.1 |
| Time to sustained ignition, sec | 154 | 119 | 131 | 126 | 102 |
| Viscosity @ 230° C., L/D 16/1, | | | | | |
| 1126N PF | | | | | |
| Calc. Visc. Pas⁻¹ | | | | | |
| @ Shear rate 100 s⁻¹ | | | | | 3342 |
| @ Shear rate 200 s⁻¹ | | | | | 2114 |
| @ Shear rate 500 s⁻¹ | | | | | 1066 |
| @ Shear rate 1000 s⁻¹ | | | | | 598 |

¹Elvax 470, commercially available from DuPont
²Elvax 460, commercially available from DuPont
³HDPE HMAO34B, commerically available from Exxon Chemicals
⁴Lotader 8840, commercially available from Elf Atochem
⁵Elvaloy AS, commercially available from DuPont
⁶Fusabond C MC 250D, commercially available from DuPont
⁷Fusabond EMB 100D, commercially available from DuPont
⁸Magnifin H−10, commercially available from Lonza
⁹Teknisperse MH100EX, commercially available from TDI
¹⁰Kisuma 5B, commercially available from Kisuma Chemicals BV, the Netherlands
¹¹Teknisperse 50G (50% Amino G), commercially available from TDI
¹²Santicizer 141, commercially available from Solutia
¹³Coad 21
¹⁴Irganox 1010, commercially available from Ciba−Geigy
¹⁵Irganox 1024 MD, commercially available from Ciba−Geigy
¹⁶Chimassorb 944FD, commerically available from Ciba−Geigy
¹⁷4−7051, commercially available from Dow Corning 3
¹⁸MB 50−314, commercially available from Dow Corning
¹⁹commercially available from Dow Corning or OSI

TABLE IV

| | 16 | 17 | 18 | 19 | 20 |
|---|---|---|---|---|---|
| Raw Material | | | | | |
| Ethylene Vinyl Acetate copolymer¹ | 60 | 60 | 60 | 60 | 60 |
| Ethylene Vinyl Acetate copolymer² | | | | | |
| HDPE³ | 15 | 15 | 22.1 | 30.4 | 15 |
| Epoxidized polyethylene⁴ | | | | | |
| Ethylene butyl acrylate | 5 | 5 | 5 | 5 | 5 |
| epoxide⁵ | | | | | |
| Maleic Acid Modified Ethylene | 5 | 5 | 5 | 5 | 5 |
| Vinyl Acetate terpolymer⁶ | | | | | |
| Maleic Acid Modified Polyethylene⁷ | 15 | 15 | 15 | 15 | 15 |
| Magnesium hydroxide⁸ | 180 | 180 | 191.4 | 204.6 | 180 |
| Silane treated magnesium | | | | 1.4 | 3.1 |
| hydroxide⁹ | | | | | |
| Magnesium hydroxide¹⁰ | | | | | |
| Silane treated magnesium | | | | | |
| hydroxide¹¹ | | | | | |
| Phosphate plasticizer¹² | 5 | 10 | 5 | 5 | |
| Stearic acid | 0.50 | 0.50 | 0.50 | 0.50 | 0.50 |
| Zinc stearate¹³ | 0.40 | 0.40 | 0.40 | 0.40 | 0.40 |
| Calcium stearate | 0.20 | 0.20 | 0.20 | 0.20 | 0.20 |
| Anti-oxidant¹⁴ | 1.00 | 1.00 | 1.00 | 1.00 | 1.00 |
| Anti-oxidant¹⁵ | 0.40 | 0.40 | 0.40 | 0.40 | 0.40 |
| Hindered amine light stabilizer¹⁶ | 0.20 | 0.20 | 0.20 | 0.20 | 0.20 |
| Resin modifier¹⁷ | 5.00 | 5.00 | 5.00 | 5.00 | 5.00 |
| Silicone lubricant¹⁸ | | 2 | 2 | 2 | 2 |
| Silane coupling agent¹⁹ | 2 | 2 | 2 | 2 | 2 |
| Total | 294.70 | 299.70 | 314.60 | 337.80 | 289.70 |
| Properties | | | | | |
| Specific Gravity | 1.48 | 1.48 | 1.49 | 1.49 | 1.48 |
| Hardness, Shore D (Inst/10 sec) | 65/60 | 62/57 | 65/60 | 66/61 | 66/61 |
| Tensile Strength (TAPEs), psi | 1850 | 1750 | 2050 | 2120 | 2060 |
| Elongation @ Break (TAPEs), % | 60 | 53 | 43 | 31 | 51 |
| Flex Modulus, Kpsi | | | | | |
| TS/UE, % Retained (100° C./7 d) | 122/57 | 124/58 | 112/70 | 109/71 | 110/86 |
| LTB, ° C. | −20 | −28 | −24 | −19 | −28 |
| Melt Index, g/10 min (190° C./10, | 1.08/7.28 | 1.93/13.36 | 0.95/6.05 | 1.53/9.68 | 0.22/1.8 |
| 20 kg) | | | | | |
| Dielectric constant @ 1 KHz | 3.52 | 3.54 | 3.58 | 3.55 | 3.43 |
| Dissipation factor @ 1 KHz | 0.0045 | 0.0035 | 0.0033 | 0.0031 | 0.0039 |
| Volume resistivity, X10\hat{ }14 | 1.110 | 2.670 | 1.700 | 1.600 | 9.110 |
| LOI, % | 39 | 35 | 39 | 40 | 42 |
| Peak Heat Release Rate @ 50 | 140 | 142 | 137 | 143 | 159 |
| Kw/sqm, Kw/sqm | | | | | |
| Average Heat Release Rate @ 50 | 83 | 79 | 84 | 88 | 88 |
| Kw/sqm, Kw/sqm | | | | | |
| Average Heat Release Rate @ 50 | 126 | 120 | 121 | 128 | 129 |
| Kw/sqm @ 3 min, Kw/sqm | | | | | |
| Total heat release @ 50 Kw/sqm, | 161 | 168 | 163 | 166 | 159 |
| MJ/sqm | | | | | |
| Effective HOC, MJ/kg | 30 | 30 | 30 | 31 | 30 |
| Peak Smoke @ 50 Kw/sqm, 1/m | 0.8 | 0.8 | 0.7 | 0.9 | 0.9 |
| Time to sustained ignition, sec | 90 | 87 | 99 | 96 | 105 |
| Viscosity @ 230° C., L/D 16/1, | | | | | |
| 1126 N PF | | | | | |
| Calc. Visc. Pas⁻¹ | | | | | |
| @ Shear rate 100 s⁻¹ | 1923 | 1322 | | 1423 | 3626 |
| @ Shear rate 200 s⁻¹ | 1328 | 1027 | | 1178 | 2068 |
| @ Shear rate 500 s⁻¹ | 749 | 638 | | 756 | 962 |
| @ Shear rate 1000 s⁻¹ | 456 | 399 | | 466 | 531 |

¹⁻¹⁹The raw materials in Table IV are the same as those listed in Table III

TABLE V

| | 21 | 22 | 23 | 24 | 25 |
|---|---|---|---|---|---|
| Raw Material | | | | | |
| Ethylene Vinyl Acetate copolymer¹ | 60 | 55 | 60 | 60 | 60 |
| Ethylene Vinyl Acetate copolymer² | | | | | |
| HDPE³ | 15 | 20 | 15 | 15 | 15 |
| Epoxidized polyethylene⁴ | | | | | |
| Ethylene butyl acrylate epoxide⁵ | 5 | 5 | 5 | 5 | |
| Maleic Acid Modified Ethylene | 5 | 5 | 5 | 5 | 10 |
| Vinyl Acetate terpolymer⁶ | | | | | |
| Maleic Acid Modified Polyethylene⁷ | 15 | 15 | 15 | 15 | 10 |
| Magnesium hydroxide⁸ | 160 | 176 | 176 | 156 | 176 |
| Silane treated magnesium hydroxide⁹ | 20 | | | | |
| Magnesium hydroxide¹⁰ | | | | 20 | |
| Silane treated magnesium | | 4 | 4 | 4 | 4 |
| hydroxide¹¹ | | | | | |
| Phosphate plasticizer¹² | | | | | |
| Stearic acid | 0.50 | 0.50 | 0.50 | 0.50 | 0.50 |
| Zinc stearate¹³ | 0.40 | 0.40 | 0.40 | 0.40 | 0.40 |
| Calcium stearate | 0.20 | 0.20 | 0.20 | 0.20 | 0.20 |
| Anti-oxidant¹⁴ | 1.00 | 1.00 | 1.00 | 1.00 | 1.00 |
| Anti-oxidant¹⁵ | 0.40 | 0.40 | 0.40 | 0.40 | 0.40 |
| Hindered amine light stabilizer¹⁶ | 0.20 | 0.20 | 0.20 | 0.20 | 0.20 |
| Resin modifier¹⁷ | 5.00 | 5.00 | 5.00 | 5.00 | 5.00 |
| Silicone lubricant¹⁸ | 2.00 | 2.00 | 2.00 | 2.00 | 2.00 |
| Total | 289.70 | 289.70 | 289.70 | 289.70 | 289.70 |
| Properties | | | | | |
| Specific Gravity | 1.49 | 1.47 | 1.49 | 1.48 | 1.49 |
| Hardness, Shore D (Inst/10 sec) | 70/65 | 70/65 | 68/63 | 68/63 | 68/63 |
| Tensile Strength (TAPEs), psi | 2340 | 2420 | 2180 | 2300 | 2260 |
| Elongation @ Break (TAPEs), % | 98 | 98 | 60 | 95 | 72 |
| Flex Modulus, Kpsi | 92.7 | 106.1 | 101.4 | 98.0 | 82.8 |
| TS/UE, % Retained (100° C./7 d) | 104/72 | 103/71 | 108/72 | 106/71 | 107/83 |
| LTB, ° C. | −43 | −37 | −37 | −37 | −36 |
| Melt Index, g/10 min(190° C./10, | 0.0/0.37 | 0.0/0.58 | 0.0/0.56 | 0.17/1.18 | 0.0/0.62 |
| 20 kg) | | | | | |
| Dielectric constant @ 1 KHz | 3.59 | 3.55 | 3.58 | 3.53 | 3.60 |
| Dissipation factor @ 1 KHz | 0.00326 | 0.00296 | 0.00284 | 0.00288 | 0.00300 |
| Volume resistivity, X10\hat{ }14 | 12.460 | 9.680 | 9.820 | 5.530 | 11.67 |
| LOI, % | 41 | 38 | 40 | 40 | 41 |
| Peak Heat Release Rate @ 50 | 147 | 151 | 155 | 167 | 166 |
| Kw/sqm, Kw/sqm | | | | | |
| Average Heat Release Rate @ 50 | 94 | 98 | 97 | 106 | 100 |
| Kw/sqm, Kw/sqm | | | | | |
| Average Heat Release Rate @ 50 | 128 | 136 | 134 | 135 | 135 |
| Kw/sqm @ 3 min, Kw/sqm | | | | | |
| Total heat release @ 50 Kw/sqm, | 165 | 164 | 163 | 176 | 162 |
| MJ/sqm | | | | | |
| Effective HOC, MJ/kg | 30 | 30 | 30 | 31 | 29 |
| Peak Smoke @ 50 Kw/sqm, 1/m | 1.2 | 1.0 | 1.0 | 1.0 | 1.2 |
| Time to sustained ignition, sec | 103 | 102 | 109 | 105 | 107 |

¹⁻¹⁸The raw materials in Table V are the same as those listed in Table III

All publications, patents, and patent applications mentioned in this application are herein incorporated by reference to the same extent as if each individual publication, patent, or patent application was specifically and individually indicated to be incorporated by reference.

A number of embodiments of the invention have been described. Nevertheless, it will be understood that various modifications may be made without departing from the spirit and scope of the invention. Accordingly, other embodiments are within the scope of the following claims.

What is claimed is:

1. A shaped article comprising a polymer composition, wherein the polymer composition includes: an olefinic polymer; a polar polymer; and a third polymer, wherein the third polymer is a graft or block copolymer, and wherein the third polymer comprises first and second polymer portions, the first polymer portion being compatible with the olefinic polymer and the second polymer portion being compatible with the polar polymer, wherein the polymer composition has a limiting oxygen index of at least about 25.

2. The article of claim 1, wherein the article is a pipe, a tube, a conduit, or a duct.

3. The article of claim 1, wherein the article is an optical fiber conduit.

4. The article of claim 1, wherein the weight ratio of the polar polymer to the olefinic polymer is 1:1 or greater.

5. The article of claim 1, wherein the weight ratio of the polar polymer to the olefinic polymer is between 1:1 and 10:1.

6. The article of claim 1, wherein the weight ratio of the polar polymer to the olefinic polymer is between 1:1 and 5:1.

7. The article of claim 1, wherein the polymer composition contains a sufficient amount of the third polymer such that the tensile strength of the composition is improved by at least about 20%, relative to a composition without the third polymer.

8. The article of claim 1, wherein the polymer composition contains a sufficient amount of the third polymer such that the tensile strength of the composition is improved by at least about 30%, relative to a composition without the third polymer.

9. The article of claim 1, wherein the polymer composition contains a sufficient amount of the third polymer such that the tensile strength of the composition is improved by at least about 40%, relative to a composition without the third polymer.

10. The article of claim 1, wherein the polymer composition contains a sufficient amount of the third polymer such that the tensile strength of the composition is improved by at least about 50%, relative to a composition without the third polymer.

11. The article of claim 1, wherein the polymer composition contains a sufficient amount of the third polymer such that the tensile strength of the composition is improved by at least about 60%, relative to a composition without the third polymer.

12. The article of claim 1, wherein the polymer composition contains a sufficient amount of the third polymer such that the tensile strength of the composition is improved by at least about 70%, relative to a composition without the third polymer.

13. The article of claim 1, wherein both the olefinic polymer and the polar polymer are substantially free of halogens.

14. The article of claim 1, wherein the composition is essentially free of halogens.

15. The article of claim 1, wherein the article consists essentially of the polymer composition.

16. The article of claim 1, wherein the polymer composition has a limiting oxygen index of at least about 30.

17. The article of claim 1, wherein the polymer composition has a limiting oxygen index of at least about 35.

18. The article of claim 1, wherein the polymer composition has a limiting oxygen index of at least about 40.

19. The article of claim 1, wherein the tensile strength of the polymer composition is at least about 1500 psi.

20. The article of claim 1, wherein the tensile strength of the polymer composition is at least about 1800 psi.

21. The article of claim 1, wherein the flex modulus of the polymer composition is at least about 80 Kpsi.

22. The article of claim 1, wherein the flex modulus of the polymer composition is at least about 85 Kpsi.

23. The article of claim 1, wherein the tensile strength of the polymer composition is at least about 1800 psi and the flex modulus of the polymer composition is at least about 80 Kpsi.
